(19) United States
(12) Patent Application Publication
(10) Pub. No.: US 2026/0073154 A1
(43) Pub. Date: Mar. 12, 2026

(54) PLAN BANK FOR API CHAINS IN ROUTING ENGINE FOR GENERATIVE MODEL-BASED DIGITAL ASSISTANT

(71) Applicant: Oracle International Corporation, Redwood Shores, CA (US)

(72) Inventors: Bhagya Gayathri Hettige, Melbourne (AU); Yakupitiyage Don Thanuja Samodhye Dharmasiri, Melbourne (AU); Ying Xu, Albion (AU); Thanh Long Duong, Melbourne (AU)

(73) Assignee: Oracle International Corporation, Redwood Shores, CA (US)

(21) Appl. No.: 19/095,559

(22) Filed: Mar. 31, 2025

Related U.S. Application Data
(60) Provisional application No. 63/691,743, filed on Sep. 6, 2024.

(51) Int. Cl. G06F 40/40; G06N 3/0475

(52) U.S. Cl. CPC G06F 40/40; G06N 3/0475

(57) ABSTRACT

Techniques for routing a user input to an action and associated parameters to generate a response to an utterance using a digital assistant and a plan bank for API chains are disclosed. A system can access, based on an utterance, a plan bank that includes composite tools. Each of the composite tools includes: a chain of tools including: application programming interface (API) tools or other composite tools, and associated logic. The system can generate, by a first generative artificial intelligence model, an action plan including one of the composite tools. The system can execute the action plan to obtain response data by executing actions associated with each of the API tools or the other composite tools. The system can generate, by a second generative artificial intelligence model, a response to the utterance based on the response data and can provide the response to the user.

### CROSS-REFERENCE TO RELATED APPLICATION

The present application is a non-provisional application of and claims the benefit and priority under 35 U.S.C. 119 (e) of U.S. Provisional Application No. 63/691,743, filed on Sep. 6, 2024, the entire contents of which is incorporated herein by reference in its entirety for all purposes.

### FIELD

The present disclosure relates generally to digital assistants, and more particularly, but not necessarily exclusively, to techniques for routing a user input to an action and associated parameters to generate a response to an utterance using a digital assistant and a plan bank for API chains.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method can be used for responding to a query using a routing engine having a plan bank with chained APIs. The method can include receiving a query from a user of an LLM-based digital assistant. The method can include identifying a set of candidate actions based on the query and contextual information associated with the query. The method can include performing routing on the set of candidate actions by: (i) determining one or more actions to perform based on the set of candidate actions, and (ii) mapping at least a subset of a set of tools from a plan bank to the one or more actions, wherein the set of tools comprises one or more composite tools that have one or more chained APIs. The method can include executing the one or more actions using the subset of the set of tools to generate a response to the query. The method can include transmitting the response to the query to the user.

According to certain embodiments of the present disclosure, a computer-implemented method can include receiving an utterance from a user in an inference mode associated with an agent. The computer-implemented method can include accessing, based on the utterance, a plan bank that includes a set of tools including one or more composite tools. Each of the one or more composite tools can include (i) a chain of tools including: application programming interface (API) tools, other composite tools, or any combination thereof, and (ii) associated logic. The computer-implemented method can include generating, by a first generative artificial intelligence model based on the plan bank and the utterance, an action plan including a composite tool of the one or more composite tools. The computer-implemented method can include executing the action plan to obtain response data. Executing the action plan can include executing one or more actions associated with each of the API tools, the other composite tools, or any combination thereof associated with the composite tool based on the associated logic to obtain the response data. The computer-implemented method can include generating, by a second generative artificial intelligence model, a response to the utterance based on the response data. The computer-implemented method can include providing the response to the user.

In some embodiments, the chain of tools is a predefined sequence of the API tools, the other composite tools, or any combination thereof. The associated logic can include business logic, input-output logic, conditional logic, or any combination thereof for completing one or more tasks using the one or more actions associated with each of the API tools, the other composite tools, or any combination thereof.

In some embodiments, the computer-implemented method can additionally include, prior to receiving the utterance from the user in the inference mode, receiving a design instruction from the user or a different user in a design mode associated with the agent. The design instruction can include the utterance or a substantially similar variant of the utterance and domain knowledge instructions to the agent that explain a chain of logic for executing the one or more actions to arrive at the response data or a substantially similar variant of the response data for responding to the utterance or the substantially similar variant of the utterance. Additionally or alternatively, the computer-implemented method can additionally include (i) generating, by a third generative artificial intelligence model based on the design instruction, the composite tool and (ii) storing the composite tool in the plan bank.

In some embodiments, the domain knowledge instructions can include (i) the API tools, the other composite tools, or any combination thereof to include in the composite tool, and (ii) a set of arguments to be used by the composite tool for executing the one or more actions associated with each of the API tools, the other composite tools, or any combination thereof. Additionally or alternatively, generating the composite tool can include creating, based on the design instruction, the predefined sequence of the API tools, the other composite tools, or any combination thereof, and the associated logic for the composite tool, and one or more placeholder arguments for the set of arguments to be used by the composite tool for executing the one or more actions.

In some embodiments, the computer-implemented method can additionally include generating, by a fourth generative artificial intelligence model based on the design instruction, metadata for the composite tool. The metadata can include (i) a name for the composite tool, (ii) a description for the composite tool, and (iii) a list of the arguments to be used by the composite tool for executing the one or more actions associated with each of the API tools, the other composite tools, or any combination thereof associated with the composite tool. The composite tool can be stored in association with the metadata in the plan bank.

In some embodiments, the description for the composite tool includes a statement identifying individual tools that are to be superseded by the composite tool, and the first generative artificial intelligence model generates the action plan based on the plan bank, the utterance, and the metadata.

In some embodiments, the first generative artificial intelligence model is a same or different model from that of the second generative artificial intelligence model, the first generative artificial intelligence model is a same or different model from that of the third generative artificial intelligence model, and the third generative artificial intelligence model is a same or different model from that of the fourth generative artificial intelligence model.

Some embodiments include a system including one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a chatbot system in accordance with various embodiments.

FIG. 2 is an exemplary architecture for a Large Language Model (LLM)-based digital assistant in accordance with various embodiments.

FIG. 3 is a simplified block diagram of a computing environment including a digital assistant that can execute an execution plan comprising actions and associated parameters for responding to an utterance from a user in accordance with various embodiments.

FIG. 4 is a block diagram illustrating a data flow for using a plan bank of API chains for routing an utterance using an LLM-based digital assistance in accordance with various embodiments.

FIG. 5 is a block diagram of a plan bank for facilitating routing of an utterance using an LLM-based digital assistance in accordance with various embodiments.

FIG. 6 is a block diagram illustrating a data flow for generating a plan bank of API chains in a design phase for facilitating routing of an utterance using an LLM-based digital assistance in accordance with various embodiments.

FIG. 7 is a flowchart of a process for using a plan bank of API chains for routing an utterance using an LLM-based digital assistance in accordance with various embodiments.

FIG. 8 is a block diagram illustrating one pattern for implementing a cloud infrastructure as a service system in accordance with various embodiments.

FIG. 9 is a block diagram illustrating another pattern for implementing a cloud infrastructure as a service system in accordance with various embodiments.

FIG. 10 is a block diagram illustrating another pattern for implementing a cloud infrastructure as a service system in accordance with various embodiments.

FIG. 11 is a block diagram illustrating another pattern for implementing a cloud infrastructure as a service system in accordance with various embodiments.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Artificial intelligence techniques have broad applicability. For example, a digital assistant can be or include an artificial intelligence driven interface that helps users accomplish a variety of tasks using natural language conversations. Conventionally, for each digital assistant, a customer may assemble one or more skills that are focused on specific types of tasks, such as tracking inventory, submitting timecards, and creating expense reports. When an end user engages with the digital assistant, the digital assistant evaluates the end user input for the intent of the user and routes the conversation to and from the appropriate skill based on the user's perceived intent. However, there are some disadvantages of traditional intent-based skills including a limited understanding of natural language, inability to handle unknown inputs, limited ability to hold natural conversations off script, and challenges integrating external knowledge.

The advent of generative models such as large language models (LLMs) (e.g., GPT-4), has propelled the field of digital assistant design to unprecedented levels of sophistication and overcome these disadvantages and others of traditional intent-based skills. An LLM is a neural network that employs a transformer architecture, specifically crafted for processing and generating sequential data, such as text or words in conversations. LLMs undergo training with extensive textual data, gradually honing an ability to generate text that closely mimics human-written or spoken language. One of the key advantages of an LLM over a traditional Language Model (LM) is the ability to generalize to novel scenarios and domains much more effectively. Given the inherent flexibility of LLMs, it is desirable to utilize an LLM in a digital assistant as an agent framework to respond to user questions.

Agent frameworks reimagined with LLMs allow seamless, out-of-the-box human-like conversation, easier asset unlocking, and high-quality routing and orchestration of requests. However, current agent frameworks are limited by the complexity of skills, as they need to continue supporting current processes to define actions (Intents), knowledge (Answer Intents), and Dialog (YAML, freemarker). While the digital assistant routing can be enhanced and some of the core routing tenets still hold, the freedom to rethink routing (in a mostly LLM world) and properly incorporate planning, reasoning, and orchestration has been a challenge give conventional digital assistant components and architecture. Nonetheless, to improve upon and provide value in the long term, certain digital assistant components and architecture need to be revised or redesigned to make the agent framework LLM-centric, which includes redefining its reasoning/routing engine, composition units, and inherent conversation capability. Accurately mapping an utterance from a user to an action can be difficult without proper routing and planning. In many instances, executing an action may require various contextually relevant information from a user. APIs, for example, often require parameters when called and may use a specific schema with set arguments to obtain a desired output. A digital assistant executing such actions may repeatedly ask a user for missing information based on a failed execution of an action or may be unable to execute complex actions that require a large amount of contextual information.

Routing and planning components and techniques can be incorporated into the digital assistants, as described herein in detail. For each digital assistant, a user may assemble one or more agents. Agents, which can include, at least in part, one or more generative models such as LLMs, are individual bots that provide human-like conversation capabilities for various types of tasks such as tracking inventory, submitting timecards, updating accounts, and creating expense reports. The agents are primarily defined using natural language. Users, such as developers, can create a functional agent by pointing the agent to assets such as Application Programming Interfaces (APIs), knowledge-based assets such as documents, URLs, images, etc., data stores, prior conversations, etc. The assets are imported to the agent, and then, because the agent is LLM-based, the user can customize the agent using natural language again to provide additional API customizations for dialog and routing/reasoning. The operations performed by an agent are realized via execution of one or more actions. An action can be an explicit one that's authored (e.g., action created for generating natural language text or audio response in reply to an authored natural language prompt such as the query-‘What is the impact of XYZ on my 401k Contribution limit?’) or an implicit one that is created when an asset is imported (e.g., actions created for Change Contribution and Get Contribution API, available through a API asset, configured to change a user's 401k contribution).

A routing agent can be employed in an LLM-based environment to determine an appropriate action among a set of candidate actions to execute in response to an utterance by a user. Routing and planning may be implemented by the routing agent, which may include or have access to a plan bank that includes composite tools, to identify, obtain, and provide input arguments for executing an action. By implementing routing, an action may be executed without repeatedly prompting a user for information or failing execution of an action. Knowing user preferences and goals while selecting an action without needing prompting by a user can also help increase the efficiency of a digital assistant and reduce user burden. A routing agent may be configured to access the plan bank, generate an action plan, and/or gather information needed for executing an action tailored to a user. In some embodiments, the routing agent may retrieve information from a context containing a searchable conversation history between a user and a digital assistant, historical execution plans, and user profile and preferences information.

A routing agent can use a list of application programming interface (API) tools and can answer a user query using the API tools in a process. The routing agent may be designed to handle complex tasks by integrating multiple APIs and executing a sequence of actions. But, some user queries can lead to complex flows of non-trivial API chaining that cannot be easily derived and that may require either business logic (e.g., validate whether user has manager access rights using an API before reading another employee's salary records) or manual linking of the inputs and outputs of the APIs when the interactions are not explicitly specified (e.g., using an output response of the first API as an explicit/implicit input to the second which cannot be linked with the provided API specification). A routing agent with a plan bank can be used that dynamically configures such complex API chaining flows, causing the complex API chaining flows to be available for the agent to use in responding to similar complex user queries. The agent plan bank can be configured by the developer at the time of routing agent setup. By incorporating domain knowledge into the agent, the developer can enhance the routing agent's capabilities beyond the standard set of API tools. Also, the agent plan bank can be used to derive API chaining flows for commonly asked user queries that lead to the same flow of actions and encapsulate these tools into a static API chain that can be used by the agent without the need to dynamically determine the flow every time the flow is executed. The above-described framework can facilitate the plan bank setup through a conversation between the agent and the developer that takes the technical details out of the picture and provides a smooth experience for the developer.

In various embodiments, a computer-implemented method can be used for identifying an action and associated parameters for generating an execution plan for a response to a user using a digital assistant. The method can include receiving an utterance from a user in an inference mode associated with an agent. For example, an inference mode associated with the agent can involve using a trained version of the agent to generate an output. In a particular example, the inference mode associated with the agent can involve the agent receiving the utterance as input and the agent generating a natural language response to the utterance based on processing performed by the agent. The method can include accessing, based on the utterance, a plan bank that includes tools that can include one or more composite tools. The plan bank can be stored at or include a repository or other suitable data storage medium that stores indications of the tools. The tools can facilitate tasks to be performed to contribute to performing the action. A composite tool can include a tool that includes more than one base tool or can include an indication of a chained tool that includes more than one base tool. In some embodiments, a base tool can correspond with a single task. For example, base tool A can involve executing API call A for performing task A. Other correspondence, such as not one-to-one, between the base tool and a task is possible. In some embodiments, each of the one or more composite tools can include (i) a chain of tools including: application programming interface (API) tools, other composite tools, or any combination thereof, and (ii) associated logic.

In some examples, any combination thereof, with respect to the chain of tools can include various scenarios. In one example, any combination thereof can include one API tool and one other composite tool. In another example, any combination thereof can include two API tools and zero other composite tools. In another example, any combination thereof can include zero API tools and two other composite tools. In some examples, any combination thereof means that a combination of tools selected from a combination of a plurality of the API tools and a plurality of the other composite tools includes at least two tools.

In some embodiments, a first generative artificial intelligence model can be used to generate an action plan that includes a composite tool of the one or more composite tools in the plan bank. The first generative artificial intelligence can receive the utterance and/or the plan bank and can generate an output for selecting a subset of composite tools from the one or more composite tools included in the plan bank based on the utterance. The selected composite tools can form the basis of the action plan, which may be or include a plan for performing an action based on the utterance. The action plan may be provided to an execution engine or other suitable portion of the digital assistant or agent to execute the action plan. Executing the action plan may involve executing each composite tool, or the base tools thereof, included in the action plan. By executing a composite tool, one or more tasks may be performed for supporting the action. For example, the composite tool can include three chained APIs for performing three tasks that support an output generated from an action that can be performed by a third-party system. In some embodiments, executing the action plan can include executing one or more tasks or actions associated with each of the API tools, the other composite tools, or any combination thereof associated with the composite tool based on the associated logic to obtain the response data. A second generative artificial intelligence model, which may be similar or identical to, or different from, the first generative artificial intelligence model, can generate a response to the utterance based on the response data. That is, the second generative artificial intelligence model can receive the response data and can generate a natural language response that can be provided to the user in response to the utterance.

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Digital Assistant and Knowledge Dialog

A bot (also referred to as an agent, chatbot, chatterbot, or talkbot), implemented as part of or as a digital assistant, is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile, web, and cloud application extensions or plugins that extend native or hybrid/responsive mobile, web, or cloud applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or pre-processed for input to a bot that is identified to be associated with the invocation name and/or communication.

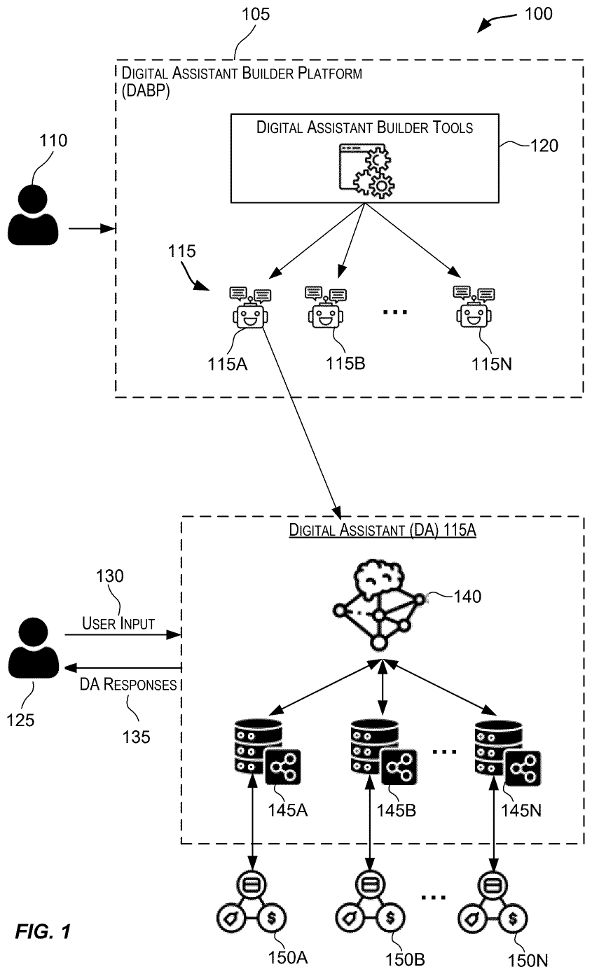

FIG. 1 is a simplified block diagram of an environment 100 incorporating a digital assistant system (also described herein as simply a digital assistant or in more specific terms with reference to implementation of agents as an agent assistant) according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistant systems (or DAs). For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

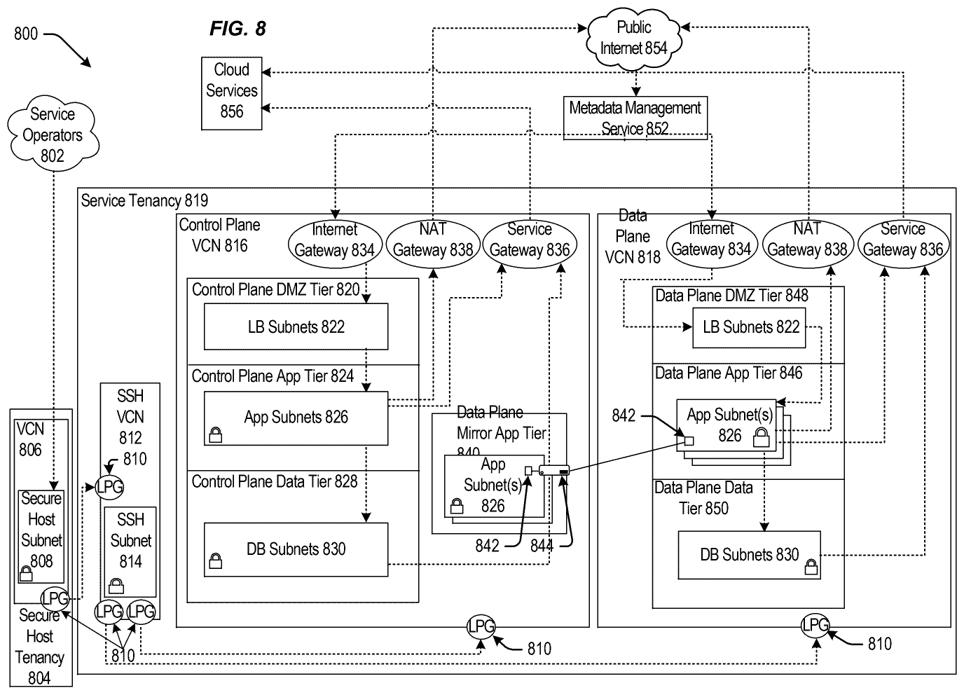

To create one or more digital assistant systems 115, the DABP 105 is equipped with a suite of tools 120, enabling the acquisition of machine learning models, agent creation, asset identification, and deployment of digital assistant systems within a service architecture for users via a computing platform such as a cloud computing platform described in detail with respect to FIGS. 8-12. In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

In some instances, the tools 120 can be utilized to access pre-trained and/or fine-tuned generative models such as LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions that an end-user can end up invoking. An agent is a container of agent actions and can be part of one or more digital assistants. Each digital assistant may contain one or more agents through a digital assistant relation, which is the intersection entity that links an agent to a digital assistant. The agent and digital assistant are implemented as bot subtypes and may be persisted into an existing BOTS table. This has advantages in terms of reuse of design-time code (e.g., Java code) and UI artefacts.

An agent action is of a specific action type (e.g., knowledge, service or API, LLM, etc.) and contains a description and schema (e.g., JSON schema) which defines the action parameters. The action description and parameters schema are indexed by semantic index and sent to the planner to select the appropriate action(s) to execute. The action parameters are key-value pairs that are input for the action execution. They are derived from the properties in the schema but may also include additional UI/dialog properties that are used for slot filling dialogs. The actions can be part of one or more classes. For example, some actions may be part of an application event subscription class, which defines an agent action that should be executed when an application event is received. The application event can be received in the form of un update application context command message. An application event property mapping class (part of the application event subscription class) specifically maps the application event payload properties to corresponding agent action parameters. An action can optionally be part of an action group. An action group may be used when importing a plugin manifest, or when importing an external API spec such as an Open API spec. An action group is particularly useful when re-importing a plugin or open API spec, so new actions can be added, existing actions can be updated, or actions that are no longer present in the new manifest or Open API spec can be removed. At runtime, an action group may only be used to limit the application context groups that are sent to the LLM as conversation context by looking up the action group name which corresponds to a context group context.

The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user can easily create explicit actions. For example, the user can choose the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets) the agent references (thus was not implicitly added as an action).

TABLE 1

| | Action | |
|---|---|---|
| | Type | Description |
| 1 | Prompt | The action is implemented using a prompt to an LLM. |
| 2 | Rich | The action is implemented using rich text. The most |
| | Text | common use case is FAQs. |
| 3 | Flow | The action is implemented using Visual Flow Designer |
| | | flow. May be used for complex cases where the developer |
| | | is not able to use the out-of-the-box dialogue and dialog |
| | | customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

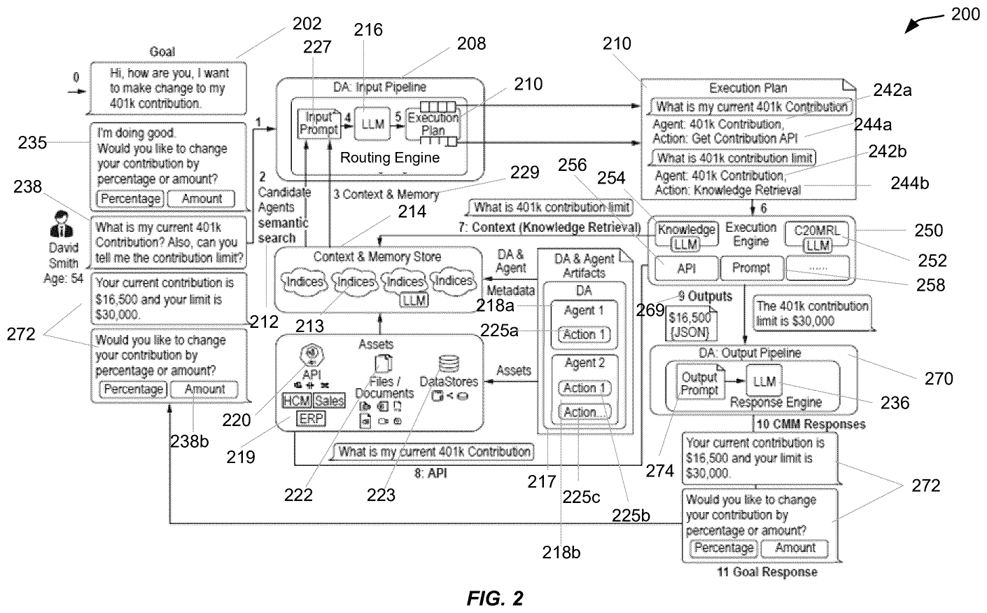

Once deployed in a production environment, such as the architecture described with respect to FIG. 2, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A via a user interface element such as a chat window. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140. Conversations shown in the chat window can be organized by thread. For example, in some applications, a conversation related to one page of an application should not be mixed with a conversation related to another page of the application. The application and/or the plugins for the application define the thread boundaries (e.g., a set of (nested) plugins can run within their own thread). Effectively, the chat window will only show the history of messages that belong to the same thread. Setting and changing the thread can be performed via the application and/or the plugins using an update application context command message. Additionally or alternatively, the thread can be changed via an execution plan orchestrator when a user query is matched to a plugin semantic action and the plugin runs in a thread different than the current thread. In this case, the planner changes threads, so that any messages sent in response to the action being executed are shown in the correct new thread. Per agent dialog thread, the following information can be maintained by the digital assistant: the application context, the LLM conversation history, the conversation history with the user, and the agent execution context which holds information about the (stacked) execution plan(s) related to this thread.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more generative models such as LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems, subsystems, and generative models as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation and/or a series of actions such as interactions with a user interface. The following is a detailed walkthrough of a conversation flow and the role and responsibility of the components, services, models, and the like of the computing environment 200 within a conversation flow. In this walkthrough, it is assumed that a user “David” is interested in making a change to his 401k contribution, and in an utterance 202, David provides the following input: Hi, how are you, I want to make a change to my 401k contribution. The utterance 202 can be communicated to the digital assistant (e.g., via a digital assistant user interface such as a text dialogue box or microphone). At this stage upon receipt of the utterance 202, a sessionizer creates a new session or retrieves the current session context and a user message publisher updates session transcript and LLM message history with the new user message (e.g., utterance 202).

In instances where the user provides the utterance 202 and/or performs an action while using an application supported by a digital assistant, the application issues update application context commands as the user interacts with the application (e.g., provides an utterance via text or audio, triggers a user interface element, navigates between pages of the application, and the like). Whenever an update application context command message is received by the digital assistant from the application, the application context processor (part of the context manager) is implemented. The application context processor performs the following tasks: (i) manages dialog threads based on the application context message, e.g., if the threadId specified with the message doesn't exist yet, a new dialog thread is created and made current, and if the threadId already exists, the corresponding dialog thread is made current, (ii) creates or updates the application context object for the current dialog thread, (iii) if a service call ID such as a REST request ID is included, the application context may be enriched (as described in greater detail herein). As should be understood, the application context only contains information that reflects the state of the application user interface and plugins (if available), it does not contain other state information (e.g., user or page state information/context).

Is some instances, when an update application context command message is received, an application event processor checks on whether the update application context command message includes an event definition. The event is uniquely identified by the following properties in the message payload: (i) context: the context path and/or the plugin path (For a top-level workspace plugin the context is set to the plugin name, for nested plugins the plugin path is included where plugins are separated with a slash, for example Patient/Vitalschart), (ii) eventType: the type of event can be one of the built in events or a custom event, and (iii) semantic object: the semantic object to which the event applies. An event can be mapped to one or more actions, and the message payload properties can be mapped to action parameters. This mapping takes place through an application event subscription. Each property in the message payload can be mapped to an agent action parameter using an application event property mapping.

In some instances, the utterance 202 and/or action performed by the user is provided directly as input to a routing engine 208 (also referred to as a planner). In other instances where the application event processor is implemented, the utterance 202 and/or action performed by the user is provided as input to the routing engine 208 when the application event processor determines an event such as receipt of utterance 202 is mapped to an agent or action associated with the digital assistant. The routing engine 208 is used by the digital assistant to create an execution plan 210 with specified parameters either from the utterance 202, the action performed by the user, the context, or any combination thereof. The execution plan 210 identifies one or more agents and/or one or more actions for the one or more agents to execute in response to the utterance 202 and/or action performed by the user.

A two-step approach can be taken via the routing engine 208 to generate the execution plan 210. First, a search 212 can be performed to identify a list of candidate agents and/or actions. The search 212 comprises running a query on indices 213 (e.g., semantic indices) of a context and memory store 214 based on the utterance 202 and/or action performed by the user. In some instances, the search 212 is a semantic search performed using words from the utterance 202 and/or representative of the action performed by the user. The semantic search uses NLP and optionally machine learning techniques to understand the meaning of the utterance 202 and/or action performed by the user and retrieve relevant information from the context and memory store 214. In contrast to traditional keyword-based searches, which rely on exact matches between the words in the query and the data in the context and memory store 214, a semantic search takes into account the relationships between words, the context of the query and/or action, synonyms, and other linguistic nuances. This allows the digital assistant to provide more accurate and contextually relevant results, making it more effective in understanding the user's intent in the utterance 202 and/or action performed by the user.

In order to run the query, the routing engine 208 calls the context and memory store 214 (e.g., a semantic index of the context and memory store 214) to get the list of candidate agents and/or actions. The following information is passed in the call: (i) the ID of the digital assistant (the ID scopes the set of agent and/or actions the semantic index will search for and thus the agents and/or actions must be part of the digital assistant), and (ii) the last X number of user messages and/or actions (e.g., X can be set to the last 5 turns), which can be configurable through the digital assistant settings. Upon receiving the list of candidate agents and/or actions, the routing engine 208 can identify an associated schema with the actions and perform slot-filling to determine any missing input arguments for the schema.

The context and memory store 214 is implemented using a data framework for connecting external data to one or more generative models such as LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request and/or action.

The response of context and memory store 214 is converted into a list of agent and/or action instances that are not just available to the digital assistant for responding to the request but also potentially capable of facilitating the generation of a response to the utterance 202 and/or action performed by the user. The list of candidate agents and/or actions includes the metadata (e.g., metadata extracted from artifacts 217 and assets 219) from the context and memory store 214 that is associated with each of the candidate agents and/or actions. The list can be limited to a predetermined number of candidate agents and/or actions (e.g., top 10) that satisfy the query or can include all agents and/or actions that satisfy the query. The list of candidate agents and/or actions with associated metadata is appended to the utterance 202 and/or action performed by the user to construct an input prompt 227 for the LLM 216. The search 212 is important to the digital assistant because it filters out agents and/or actions that are unlikely to be capable of facilitating the generation of a response to the utterance 202 and/or action performed by the user. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs can take the input prompt as input.

In some instances, one or more knowledge actions are additionally appended to the list of candidate agents and the utterance 202. The knowledge actions allow for additional knowledge to be acquired that is pertinent to the utterance 202 and/or action performed by the user (this knowledge is typically outside the scope of the knowledge used to train an LLM of the digital assistant). The are two types of knowledge action sources: (i) structure: the knowledge source defines a list of pre-defined questions that the user might ask and exposes them as some APIs (e.g., Multum), and (ii) unstructured: with the knowledge source, the user has unlimited ways to ask questions and the knowledge source exposes a generic query interface (e.g., medical documents (SOAP notes, discharge summary, etc.)).

In some instances, conversation context 229 concerning the utterance 202 are additionally appended to the list of candidate agents and the utterance 202. The conversation context 229 can be retrievable from one or more sources including the context and memory store 214, and includes user session information, dialog state, conversation or contextual history, application context, page context, user information, or any combination thereof. For example, the conversation context 229 can include: the current date and time, needed to resolve temporal references in user query like “yesterday”, or “next Thursday”, additional context, which contains information such as user profile properties and application context groups with semantic object properties, and the chat history with the digital assistant (and/or other digital assistant or system internal or external to the computing environment 200.

The second step of the two-step approach is for the LLM 216 to generate an execution plan 210 based on the input prompt 227. The LLM 216 can be invoked by creating an LLM chat message with role system passing in the input prompt 227, converting the candidate agents and/or actions into LLM function definitions, retrieving a proper LLM client based on the LLM configuration options, optionally transforming the input prompt 227, LLM chat message, etc. into a proper format for the LLM client, and sending the LLM chat message to the LLM client for invoking the LLM 216. The LLM client then sends back an LLM success response in CLMI format or a provider specific response is converted back to the LLM success response in CLMI format using an adapter such as OpenAIAdapter (or send back or is converted to an LLM error response in case an unexpected error occurred). An LLM call instance is created and added to the conversation history which captures all the request and response details including the execution time.

The LLM 216 has a deep generative model architecture (e.g., a reversible or autoregressive architecture with) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. For example, to generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage] [Amount]) to the input prompt 227 that can obtain the missing information such that the LLM 216 is able to generate a complete execution plan 210. In some instances, the response may be rendered within a dialogue box of a UI having one or more UI elements allowing for an easier response by the user. In other instances, the response may be rendered within a dialogue box of a UI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response-additional query 238—is input into the routing engine 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

In some instances, the utterance 202 by the user may be determined by the LLM 216 to be non-sequitur (i.e., an utterance that does not logically follow from the previous utterance in a dialogue or conversation). In such an instance, an execution plan orchestrator can be used to handle the switch among different dialog paths. The execution plan orchestrator is configured to track all the ongoing conversation paths, create a new entry if a new dialog path is created and pause the current ongoing conversation if any, remove the entry if the conversation completes based on the metadata of the new action or user preference, it might generate a prompt message when starting a non-sequitur or resuming the previous one, manage the dialog for the prompt message and either proceed or restore the current conversation, confirm or cancel when the user responds to the prompt for the non-sequitur. and manages a cancel or exit from a dialog.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like. for executing the actions of agents and implementing the execution plan 210. For example, the natural language-to-programming language translator 252, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or provue network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload

Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount? [Percentage] [Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

### Block Diagrams for Computing Environments Including a Routing Agent for Digital Assistant

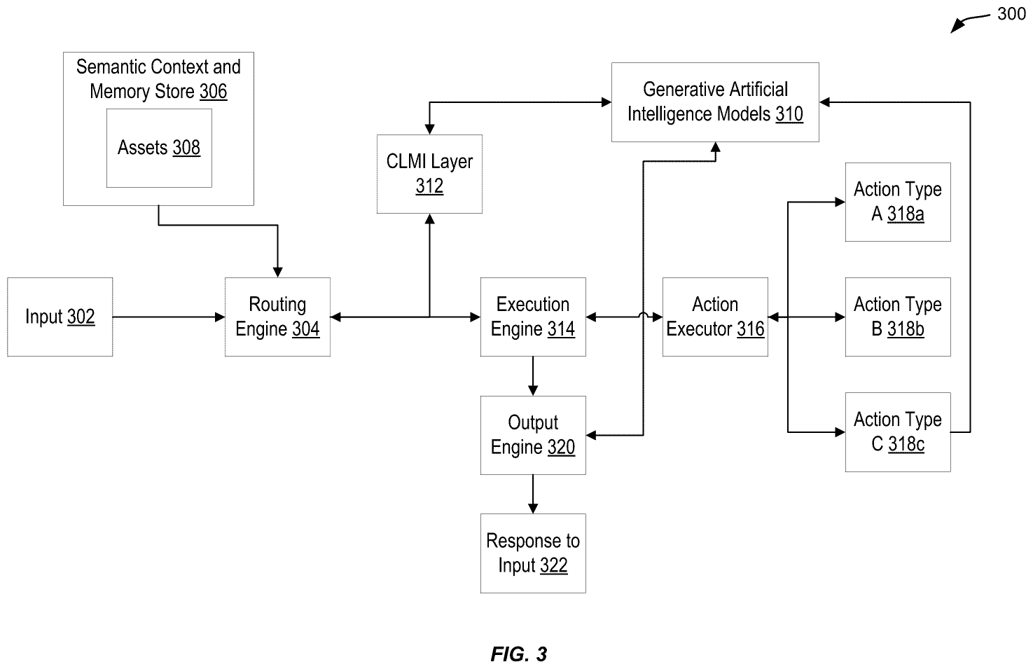

FIG. 3 is a simplified block diagram of a computing environment (e.g., computing environment 200 described with respect to FIG. 2) including a digital assistant 300 that can execute an execution plan comprising actions and associated parameters for responding to an utterance from a user in accordance with various embodiments. In some embodiments, the utterance may be provided from the user to the digital assistant 300 via input 302. The input 302 may be or include natural language utterances that can include text input, voice input, image input, or any other suitable input for the digital assistant 300. For example, the input 302 may include text input provided by the user via a keyboard or touchscreen of a computing device used by the user. In other examples, the input 302 may include spoken words provided by the user via a microphone of the computing device. In other examples, the input 302 may include image data, video data, or other media provided by the user via the computing device. Additionally or alternatively, the input 302 may include indications of actions to be performed by the digital assistant 300 on behalf of the user. For example, the input 302 may include an indication that the user wants to order a pizza, that the user wants to update a retirement account contribution, or other suitable indications.

The input 302 may be provided to a routing engine 304, which may also be referred to as a routing agent. The routing engine 304 may generate an execution plan based on the input 302 and based on context provided to the routing engine 304. The routing engine 304 may receive the input 302 and may make a call to a semantic context and memory store 306 to retrieve the context. In some embodiments, the semantic context and memory store 306 includes one or more assets 308, which may be similar or identical to the assets 219. The routing engine 304 may provide at least a portion of the input 302 to the semantic context and memory store 306, which can perform a semantic search on the assets 308 and/or other knowledge included in the semantic context and memory store 306. The semantic search may generate a list of candidate actions, or candidate tools, from among all actions that can be performed via one or more of the assets 308, that may be used to address the input 302 or any subset thereof. In some embodiments, the candidate actions may be generated only based on contextual information. For example, the input 302 may be compared with metadata of the actions to generate the candidate actions. Table 2 lists particular examples of context information and candidate actions that can be received by the routing engine 304 and an execution plan that can be generated by the routing engine 304.

TABLE 2

| Routing | | | |
|---|---|---|---|
| Component | Example | | |
| Context | • | User Profile: | |
| Information | | - | Employee Id: 765943 |
| | | - | Name: Natasha Gill |
| | | - | Age: 40 |
| | | - | Country: USA |
| | • | Conversation History: | |
| | | | [User]: Hi, I'd like to submit an expense. |
| | | | [Assistant]: To create the expense, I need to know the |
| | | | amount, date and the merchant for this expense. Can you |
| | | | provide the amount first? |
| | | | [User]: Burger King was the merchant. |
| | | | [Assistant]: Please provide me with the amount for this |
| | | | expense. |
| | | | [User]: You're right, 8L it was. |
| | | | [Assistant]: Sorry, the provided input is invalid. To create the |
| | | | expense, I need the amount and the date for this expense. Can |
| | | | you provide the amount first? |
| Candidate | • | “Create_Expense”: | |
| Actions | | - | Agent: Expense agent |
| or Tools | | - | Description: Create expense |
| | | - | args JSON schema: [{“name”: “employee_id”, |
| | | | “description”: “Employee ID”, “type”: “Integer”, “required”: |
| | | | true}, {“name”: “amount”, “description”: “Expense |
| | | | amount”, “type”: “Float”, “required”: true}, {“name”: |
| | | | “date”, “description”: “Expense date”, “type”: “Date”, |
| | | | “required”: true}, {“name”: “merchant”, “description”: |
| | | | “Merchant name”, “type”: “String”, “required”: true}, |
| | | | {“name”: “location”, “description”: “Location of the |
| | | | expense”, “type”: “String”, “required”: false}] |
| | | - | Action type: API_CALL |

| | |
|---|---|
| • | “Get_Expense_Details”: |

| | |
|---|---|
| - | Agent: Expense agent |
| - | Description: Retrieve details of a specific expense |
| - | args JSON schema: [{“name”: “expense_id”, “description”: |
| | “Expense ID”, “type”: “Integer”, “required”: true}] |

| | |
|---|---|
| • | “Update_Expense”: |

| | |
|---|---|
| - | Agent: Expense agent |
| - | Description: Update an existing expense |
| - | args JSON schema: [{“name”: “expense_id”, “description”: |
| | “Expense ID”, “type”: “Integer”, “required”: true}, {“name”: |
| | “employee_id”, “description”: “Employee ID”, “type”: |
| | “Integer”, “required”: true}, {“name”: “amount”, |
| | “description”: “Expense amount”, “type”: “Float”, |
| | “required”: true}, {“name”: “date”, “description”: “Expense |
| | date”, “type”: “Date”, “required”: true}, {“name”: |
| | “merchant”, “description”: “Merchant name”, “type”: |
| | “String”, “required”: true}, {“name”: “location”, |
| | “description”: “Location of the expense”, “type”: “String”, |
| | “required”: false}] |
| - | type: API_CALL |

| | |
|---|---|
| • | “Delete_Expense”: |

| | |
|---|---|
| - | Agent: Expense agent |
| - | Description: Delete an expense |
| - | args JSON schema: [{“name”: “expense_id”, “description”: |
| | “Expense ID”, “type”: “Integer”, “required”: true}] |
| - | Action type: API_CALL |

| | |
|---|---|
| • | “Get_All_Expenses”: |

| | |
|---|---|
| - | Agent: Expense agent |
| - | Description: Get all expenses for a given employee ID |
| - | args JSON schema: [{“name”: “employee_id”, |
| | “description”: “Employee ID”, “type”: “Integer”, “required”: |
| | true}] |
| - | Action type: API_CALL |

| | |
|---|---|
| • | “Get_Expense_Categories”: |

| | |
|---|---|
| - | Agent: Expense agent |
| - | Description: Get all expense categories |
| - | JSON schema: [ ] |
| - | Action type: API_CALL |

| | |
|---|---|
| • | “Expense_FAQ”: |

| | |
|---|---|
| - | Agent: Expense knowledge agent |
| - | Description: The document provides answers to expenses |
| | submission related FAQ: expense reimbursement policies, |
| | documentation requirements, approval processes, and |
| | timelines for submitting expense reports. |
| - | args JSON schema: [ ] |
| - | Action type: KNOWLEDGE |

| | |
|---|---|
| • | “OOD_Action”: |

| | |
|---|---|
| - | Agent: OOD agent |
| - | Description: No matching action for the given question |
| - | args JSON schema: [ ] |
| - | Action type: OOD |

| | |
|---|---|
| Execution | [{ |
| Plan | “action”: “Create_Expense”, |
| | “agent”: “Expense agent”, |
| | “args”: { |
| | “employee_id”: 765943, |
| | “amount”: null, |
| | “date”: null, |
| | “merchant”: “Burger King”, |
| | “location”: null |
| | }] |

As a particular example, the routing engine 304 receives the context information and candidate actions listed in Table 2 as part of a prompt transmitted to the routing engine 304. The input 302 can be an indication the user wants to create an expense, or it may a continuation of the conversation listed with the conversation history in Table 2. Each candidate action has an associated agent, description, JSON schema, and action type. The JSON schema may contain input argument slots with specified types that are required or optional. As an example, the “Get Expense Details” action has an associated JSON schema with one input argument slot for an expense ID that is an integer and is required. Some actions such as “Get Expense Categories” have an associated schema without any input argument slots.

The routing engine 304 may use the candidate actions to form an input prompt for a generative artificial intelligence model. The generative artificial intelligence model may be or be included in generative artificial intelligence models 310, which may include one or more generative models such as LLMs. The routing engine 304 may be communicatively coupled with the generative artificial intelligence models 310 via a common language model interface layer (CLMI layer 312). The CLMI layer 312 may be an adapter layer that can allow the routing engine 304 to call a variety of different generative artificial intelligence models that may be included in the generative artificial intelligence models 310. For example, the routing engine 304 may generate an input prompt and may provide the input prompt to the CLMI layer 312 that can convert the input prompt into a model-specific input prompt for being input into a particular generative artificial intelligence model. The routing engine 304 may receive output from the particular generative artificial intelligence model that can be used to generate an execution plan. The output may be or include the execution plan. In other embodiments, the output may be used as input by the routing engine 304 to allow the routing engine 304 to generate the execution plan. The output may include a list that includes one or more executable actions based on the utterance included in the input 302. In some embodiments, the execution plan may include an ordered list of actions to execute for addressing the input 302.

In some instances, the routing engine 304 may perform slot-filling to supplement any information required by the execution engine 314 to execute the execution plan. In some examples, the output of the routing engine 304 to be sent to the execution engine 314 can be in a JSON schema format. The output may have an associated schema with specified key-value pairs required to pass to the execution engine 314 and the routing engine 304 can determine if any information needed for a selected action is missing. The routing engine 304 may use the conversation history, text from the input 302, the context or any combination thereof to determine the missing information. For example, an action may require information related to the current date and the routing engine 304 can retrieve the current data from the input 302 or from available information within a context. The routing engine 304 may tailor an action to a user by identifying user preferences and filling input argument slots within a schema according to the user preferences.

As a particular example, the routing engine 304 may use the contextual information listed in Table 2 and the input 302 to select the “Create Expense” action among the candidate actions listed in Table 2. “Create Expense” is associated with an API call as its action type and is associated with a JSON schema with input arguments including a required integer employee ID, a required float expense amount, a required date formatted as type date, a required string merchant name, and an optional string describing the location of the expense. The routing engine 304 retrieves the employee ID from the user profile data retrieved with the contextual information and can determine the merchant by looking at the conversation history and recognizing the user previously uttered “Burger King was the merchant.” The routing engine 304 may be unable to determine the remaining input argument slots and instead sets their values to null. The routing engine 304 generates an execution plan as listed in Table 2 including the action, agent, and arguments for the schema.

The routing engine 304 can transmit the execution plan to the execution engine 314 for executing the execution plan. The routing engine 304 may transmit the execution plan along with any information required by the execution engine 314. The execution engine 314 may perform an iterative process for each executable action included in the execution plan. For example, the execution engine 314 may, for each executable action, identify an action type, may invoke one or more states for executing the action type, and may execute the executable action using an asset to obtain an output. The execution engine 314 may be communicatively coupled with an action executor 316 that may be configured to perform at least a portion of the iterative process. For example, the action executor 316 can identify one or more action types for each executable action included in the execution plan. In a particular example, the action executor 316 may identify a first action type 318a for a first executable action of the execution plan. The first action type 318a may be or include a semantic action such as summarizing text or other suitable semantic action. Additionally or alternatively, the action executor 316 may identify a second action type 318b for a second executable action of the execution plan. The second action type 318b may involve invoking an API such as an API for making an adjustment to an account or other suitable API. Additionally or alternatively, the action executor 316 may identify a third action type 318c for a third executable action of the execution plan. The third action type 318c may be or include a knowledge action such as providing an answer to a technical question or other suitable knowledge action. In some embodiments, the third action type 318c may involve making a call to at least one generative artificial intelligence model of the generative artificial intelligence models 310 to retrieve specific knowledge or a specific answer. In other embodiments, the third action type 318c may involve making a call to the semantic context and memory store 306 or other knowledge documents.

In some instances, the execution engine 314 may not receive all of the information required by the action executor 316 to perform a requested action. The execution engine 314 may instead generate an execution failed status and the execution failed status may be sent to the response engine 320. As a particular example, the execution engine 314 may receive the execution plan listed in Table 2. The arguments for amount, date, and location for the “Create Expense” action in the execution plan are set to null. According to the JSON schema associated with the “Create Expense” action, amount and date are required arguments. A call to an API without the required argument can fail, and the execution engine 314 may indicate the missing arguments in an execution status or attempt to call the API and generate an execution status based on the output of the API call.

The action executor 316 may continue the iterative process based on the action types indicated by the executable actions included in the execution plan. Once the action executor 316 identifies the action types, the action executor 316 may identify and/or invoke one or more states for each executable action based on the action type. A state of an action may involve an indication of if or whether an action can be or has been executed. For example, the state for a particular executable action may include “preparing” “ready” “executing” “success” “failure” or any other suitable states. The action executor 316 can determine, based on the invoked state of the executable action, whether the executable action is ready to be executed, and, if the executable action is not ready to be execute, the action executor 316 can identify missing information or assets required for proceeding with executing the executable action. In response to determining that the executable action is ready to be executed, and in response to determining that no dependencies exist (or existing dependencies are satisfied) for the executable action, the action executor 316 can execute the executable action to generate an output.

The action executor 316 can execute each executable action, or any subset thereof, included in the execution plan to generate a set of outputs. The set of outputs may include knowledge outputs, semantic outputs, API outputs, and other suitable outputs. The action executor 316 may provide the set of outputs to an output engine 320. The output engine 320 may be configured to generate a second input prompt based on the set of outputs. The second input prompt can be provided to at least one generative artificial intelligence model of the generative artificial intelligence models 310 to generate a response 322 to the input 302. The output engine 320 may make a call to the at least one generative artificial intelligence model to cause the at least one generative artificial intelligence model to generate the response 322, which can be provided to the user in response to the input 302.

In some instances, the response engine 320 may receive an execution failed status from the execution engine 314. The execution failed status may contain information about why the execution engine 314 was unable to complete an action. The response engine 320 may produce a response 322 to the user indicating the agent requires supplemental information to complete an action. The response 322 may request the user to input the required information. In some examples, the response 322 may indicate that an action cannot be completed and may provide a reason indicating why the action cannot be completed. In some examples, the response 322 may be sent to a user before an action is executed and may ask a user to confirm details of an execution plan. As a particular example, the response engine 320 can request the expense amount and date from the user to complete the “Create Expense” action as listed in Table 2. Upon receiving the requested expense amount from the user, the routing engine 304 can update the execution plan.

In some embodiments, the at least one generative artificial intelligence model used to generate the response 322 may be similar or identical to, or otherwise the same model, as the at least one generative artificial intelligence model used to generate output for generating the execution plan.

Block Diagrams for Computing Environments Including a Routing Agent with a Plan Bank for Digital Assistant

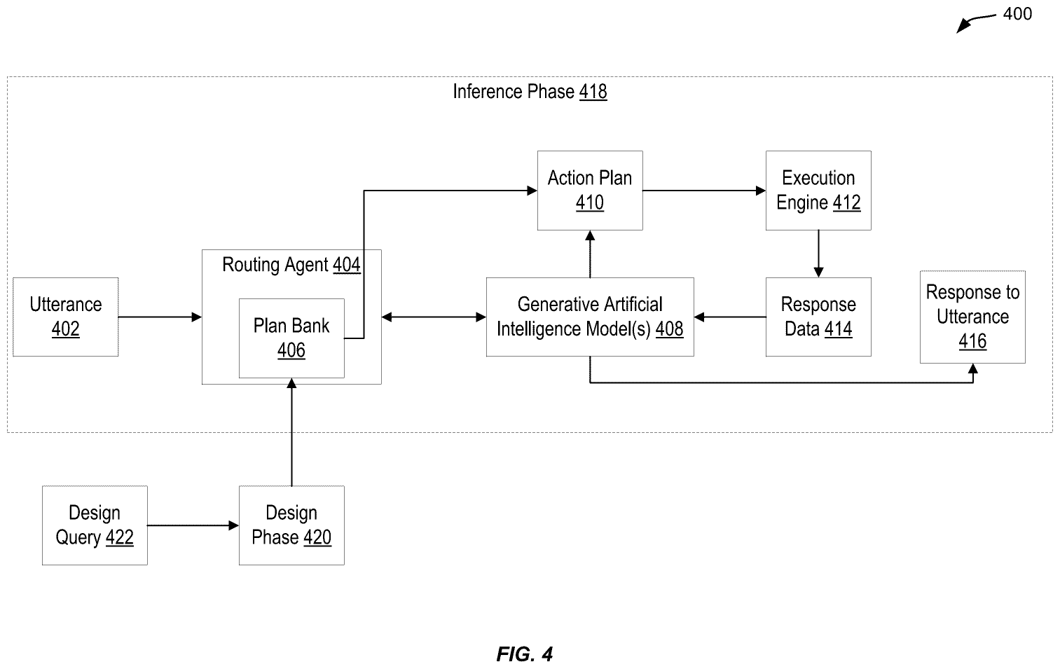

FIG. 4 is a block diagram illustrating a data flow 400 for using a plan bank of API chains for routing an utterance using a generative model-based digital assistance, according to at least one embodiment. As illustrated in FIG. 4, the data flow 400 may begin with an utterance 402. In some embodiments, the utterance 402 may include a natural language utterance, which may be provided via vocalized instructions, text input, physical gestures, etc. from a user, that can indicate that a user has requested an action to be performed. The action can include an adjustment to an account associated with the user, can include a request for information about data associated with the user, etc. The utterance 402 can be provided to a routing agent 404. For example, the user may be using a computing device, such as a mobile computing device, a laptop, a personal computing device, or the like, to communicate with a digital assistant that can include or otherwise have access to the routing agent 404. The user may input the utterance 402 into a field provided by the digital assistant, and the digital assistant can provide the utterance 402 to the routing agent 404 for further processing.

The routing agent 404 may receive the utterance 402 and may access a plan bank 406, one or more generative artificial intelligence models 408, or a combination thereof for processing the utterance 402. For example, the routing agent 404 may select the plan bank 406, from a set of possible plan banks, based on the utterance 402 in which the plan bank 406 is most relevant to the utterance 402 compared with other plan banks of the set of possible plan banks. Additionally or alternatively, the routing agent 404 may provide the plan bank 406 and the utterance 402 to the one or more generative artificial intelligence models 408. The one or more generative artificial intelligence models 408 can include one or more large language models or other suitable generative artificial intelligence models that are configured to receive input, such as natural language utterances, plan banks, etc., and to generate output that can include an action plan 410. In an example, the routing agent 404 can transmit the utterance 402 to the one or more generative artificial intelligence models 408 along with an access code that allows the one or more generative artificial intelligence models 408 to access the plan bank 406 for determining what is available via the plan bank 406 for generating the action plan 410.

In some embodiments, a first generative artificial intelligence model of the one or more generative artificial intelligence models 408 can receive the utterance 402 and the plan bank 406, or access thereto, and the first generative artificial intelligence model can generate the action plan 410. By generating the action plan 410, the first generative artificial intelligence model can select a subset of the composite tools included in the plan bank 406 for performing one or more actions requested by the user as indicated by the utterance 402. For example, the first generative artificial intelligence model can identify a first composite tool from the plan bank 406 that can be executed to perform one or more tasks for supporting the action indicated by the utterance 402. The first generative artificial intelligence model may select the subset of the composite tools based at least in part on associated logic, such as business logic, input-output logic, conditional logic, or any combination thereof. For example, the first generative artificial intelligence model can receive the associated logic of each composite tool included in the plan bank 406 and can make a selection of the subset of the composite tools by mapping the composite tools and associated logic to one or more tasks for supporting the action indicated by the utterance 402.

In some embodiments, the action plan 410 can be provided to an execution engine 412 that can execute the subset of the composite tools included in the action plan 410. The execution engine 412 can receive the action plan 410 from the one or more generative artificial intelligence models 408 and can parse the action plan 410 to identify the subset of the composite tools included in the action plan 410. In some embodiments, parsing the action plan 410 can include identifying one or more API calls or other calls to execute for executing the subset of the composite tools. Additionally or alternatively, parsing the action plan 410 can include determining one or more arguments and/or argument slots for the one or more API calls or other calls. If one or more of the arguments and/or arguments slots are missing or empty, the digital assistant may return a response to the utterance 402 requesting additional information or may execute other operations for filling the argument slots to reduce time and inaccuracies for responding to the utterance 402.

In some embodiments, the execution engine 412 can execute the action plan 410 to generate and/or obtain response data 414. The response data 414 can be obtained by causing execution of the APIs associated with the subset of the composite tools included in the action plan 410, by causing the one or more tasks to be performed by executing the subset of the composite tools, etc. In an example, the execution engine 412 can execute a first composite tool included in the action plan 410, and the first composite tool can include three API tools chained by associated logic. The execution engine 412 can execute the three API tools according to the associated logic to perform tasks associated with execution of the three API tools. In some embodiments, executing the action plan 410 can include executing one or more actions or tasks associated with each of the API tools of the subset of the composite tools, the other composite tools of the subset of the composite tools, or any combination thereof based on the associated logic to obtain the response data 414. Outputs from executing the three API tools according to the associated logic can include the response data 414.

The execution engine 412 can provide the response data 414 to the digital assistant, or to the one or more generative artificial intelligence models 408 to generate a response 416 to the utterance 402. For example, the response data 414 can be provided to a second generative artificial intelligence model that can generate the response 416 as output based on the response data 414 as input. In some embodiments, the second generative artificial intelligence model may be different than the first generative artificial intelligence model, though in other embodiments, the second generative artificial intelligence model may be similar or identical to the first generative artificial intelligence model. The digital assistant, such as via the one or more generative artificial intelligence models 408, can output the response 416 to the user such as by populating the response 416 on a user interface that can be used to facilitate one or more interactions, such as a conversation, between the user and the digital assistant.

The above operations described with respect to FIG. 4 can be performed in an inference phase 418 of the digital assistant that includes the routing agent 404 with the plan bank 406. In some embodiments, the plan bank 406 can be generated and/or adjusted in a design phase 420 of the digital assistant in which the design phase 420 may be separate from the inference phase 418.

In some embodiments, the design phase 420 can be initiated via a design query 422 that can be provided to the digital assistant. The design query 422 may be generated via a computing device that can be used to communicate with the digital assistant. The design query 422 may be caused to be generated by a user of the computing device, and the user may be different from the user that generated the utterance 402, though in other embodiments, the user of the computing device may be similar or identical to the user that caused to be generated the design query 422. In some embodiments, the design query 422 can include instructions for generating and/or adjusting the plan bank 406. For example, the design query 422 can include instructions for encoding complex sequences of tasks or APIs for performing the tasks. The instructions can be provided to the one or more generative artificial intelligence models 408 for encoding the instructions as one or more additional composite tools that can be saved to or otherwise included in the adjusted plan bank.

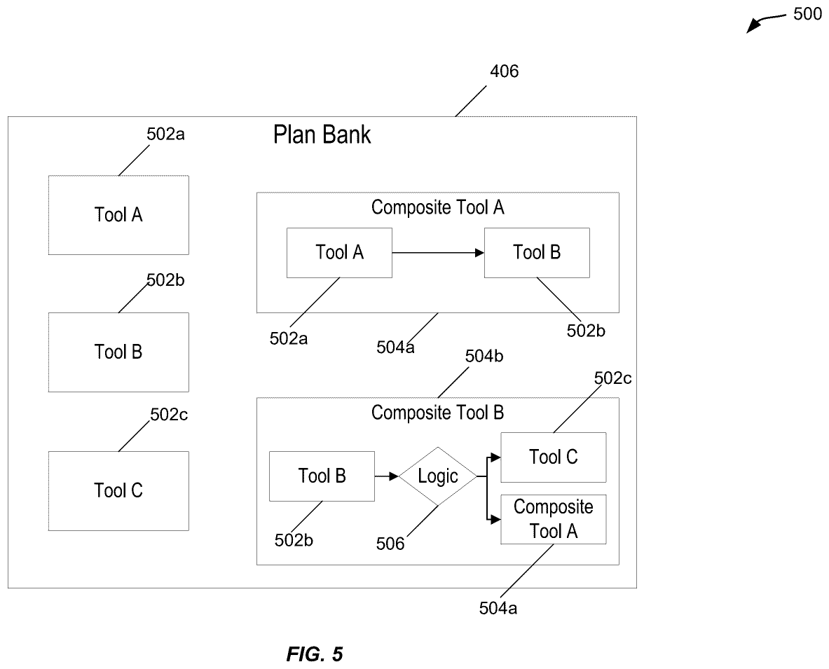

FIG. 5 is a block diagram of a plan bank 406 for facilitating routing of an utterance 402 using a generative model-based digital assistance, according to at least one embodiment. As illustrated in FIG. 5, the plan bank 406 can include a set of tools such as tool A 502a, tool B 502b, tool C 502c, composite tool A 504a, and composite tool B 504b, though any additional, alternative, or fewer tools can be included in the plan bank 406. While described as including or indicated APIs or API chains, the tools included in the plan bank 406 can include other suitable types of calls to facilitate performance of corresponding tasks to support an action in response to the utterance 402. In some embodiments, the set of tools included in the plan bank 406 may be selected to include in the plan bank 406 based on a design phase 420 of a digital assistant for configuring the plan bank 406 to be able to perform actions based on received utterances. Additionally or alternatively, a tool can include a candidate other type of tool that can have associated with it an API or other means for performing a task when executed to support an action in response to the utterance 402.

In some embodiments, tool A 502a, tool B 502b, and tool C 502c may include base tools that can each include or indicate one API for performing a corresponding task. Additionally or alternatively, composite tool A 504a and composite tool B 504b may include or indicate multiple base tools, which may be chained together and may include a set of chained APIs, for performing one or more corresponding tasks. Composite tool A 504a and composite tool B 504b can each include a set of chained APIs, according to associated logic, for performing the one or more corresponding tasks. For example, composite tool A 504a can include tool A 502a and tool B 502b chained together by associated logic. As illustrated in FIG. 5, the associated logic of composite tool A 504a involves executing tool A 502a to perform a first task based on a first API associated with tool A 502a and then executing tool B 502b to perform a second task based on a second API associated with tool B 502b.

As illustrated in FIG. 5, composite tool B 504b may involve a more complex API chain than composite tool A 504a. For example, composite tool B 504b may include tool B 502b, tool C 502c, and composite tool A 504a. The APIs that form composite tool B 504b may be chained based on associated logic 506. As illustrated in the plan bank 406, composite tool B 504b may begin with execution of tool B 502b, and an output of executing tool B 502b can be evaluated according to the associated logic 506. For example, if the output satisfies a conditional evaluation associated with the associated logic 506, then composite tool B 504b can proceed with executing tool C 502c, and if the output does not satisfy the conditional evaluation associated with the associated logic 506, then composite tool B 504b can proceed with executing composite tool A 504a, as described above.

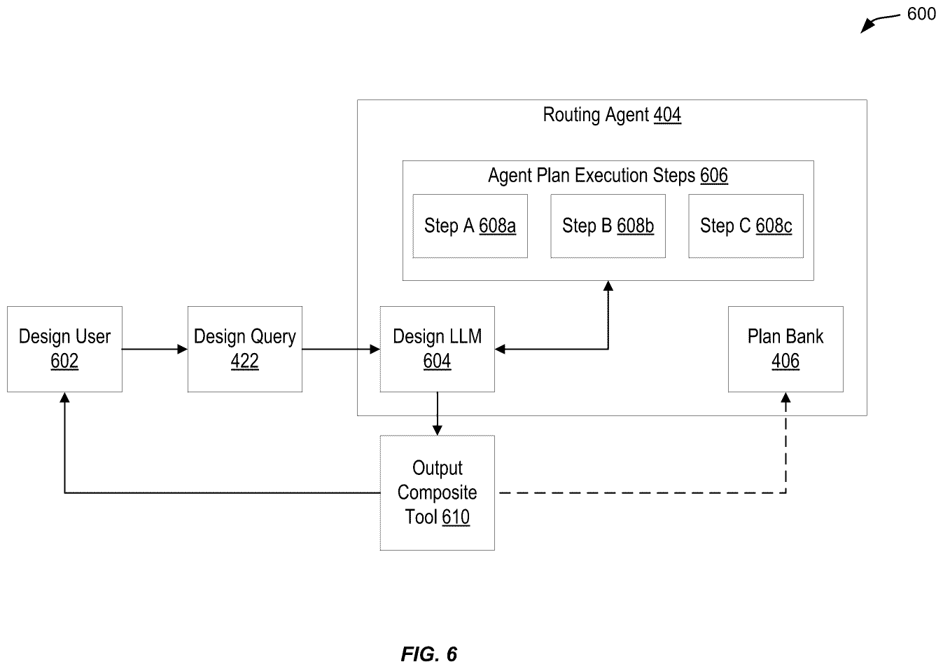

FIG. 6 is a block diagram illustrating a data flow 600 for generating a plan bank 406 of API chains in a design phase 420 for facilitating routing of an utterance 402 using a generative model-based digital assistance, according to at least one embodiment. As illustrated in FIG. 6, the data flow 600 can begin with a design user 602. In some embodiments, the design user 602 may be different from a user that generates the utterance 402. For example, the design user 602 may be a developer of the digital assistant, while the user that generates the utterance 402 may be an end user of the digital assistant, though in other embodiments, the design user 602 and the user that generates the utterance 402 may be the same user.

In some embodiments, the design user 602 may generate, or cause to be generated, a design query 422 that can be used to generate or adjust at least a portion of the plan bank 406. For example, the digital assistant may provide a user interface to a client device used by the design user 602, and the user interface may receive one or more interactions from the design user 602 for generating the design query 422. In some embodiments, the design query 422 may include instructions for configuring the digital assistant, or the plan bank 406 thereof. Additionally or alternatively, the design query 422 can include an example of a possible query that a user can generate as the utterance 402 and can include possible or available tools to use.

The design query 422 can be transmitted to the digital assistant or any model, service, or agent (e.g., the routing agent 404) thereof. For example, the design query 422 can be transmitted to a design generative model such as design LLM 604 of the routing agent 404, and the design LLM 604 can be used to process the design query 422. In some embodiments, the design LLM 604 can receive the design query 422 and can generate a set of steps, such as an agent plan execution steps 606, for executing the example of the query. The agent plan execution steps 606 can include proposed steps, such as tools, for addressing the example of the query using the available tools. In an example, the agent plan execution steps 606 can include step A 608a, step B 608b, and step C 608c, though any additional, alternative, or fewer steps for addressing the example of the query. In some embodiments, the steps included in the agent plan execution steps 606 can be listed as tools, such as tool A 502a, tool B 502b, tool C 502c, etc. Additionally or alternatively, the steps included in the agent plan execution steps 606 can be chained via associated logic. For example, step A 608a, step B 608b, and step C 608c can each include or indicate an API call, or other suitable call, and a particular order of executing step A 608a, step B 608b, and/or step C 608c can be determined by the design LLM 604 and included in the agent plan execution steps 606. The particular order can be determined based on the instructions included in the design query 422, can be based on associated logic, which may include business logic, input-output logic, and/or conditional logic.

In some embodiments, the agent plan execution steps 606 can be generated and/or received by the design LLM 604, and the design LLM 604 can generate an output composite tool 610 based on the agent plan execution steps 606. For example, the design LLM 604 can formulate the output composite tool 610 by determining an order and/or dependency of executing the steps of the agent plan execution steps 606, by chaining the steps of the agent plan execution steps 606 according to associated logic, etc. The output composite tool 610 may include or indicate a chain of APIs, or other suitable calls, for supporting an action in response to the example of the query included in the design query 422. In some embodiments, the output composite tool 610 can include a proposed tool name, a proposed tool description, and a proposed list of input arguments, each generated by the design LLM 604, for executing the output composite tool 610. The output composite tool 610 can be transmitted to the design user 602 for performing a confirmation process to (i) confirm that the output composite tool 610, and the name, description, and argument list thereof, is acceptable or (ii) make changes to the output composite tool 610. Upon confirmation that the output composite tool 610, or an adjusted version thereof, is acceptable, the digital assistant can save the output composite tool 610 to the plan bank 406.

In some embodiments, a list of complex queries associated with business logic and/or implicit API chaining may be or be included in prerequisites for a plan bank configuration for the plan bank 406. Commonly asked user queries can also be collected from a standard set of tools, for example that may not include a composite tool, in which the agent can have a predefined static composite tool rather than asking the agent to derive a dynamic plan. The design user 602 can, in combination with the design LLM 604, come up with high quality tool descriptions to define a composite API tool such as the output composite tool 610. The current plan bank setup provides an LLM-generated tool description as a suggestion for the design user 602 so that the design user 602 can review and edit the output composite tool 610, if necessary.

The plan bank setup framework can be a smooth process for the design user 602, and the agent and design user 602 can have a natural language conversation to generate and/or adjust the plan bank 406. The plan bank 406 can be tested with an example-based approach in which the design user 602 provides a complex example, such as via the design query 422, and an instruction to the agent to chain APIs to answer the question. The design query 422 can include an example user query that may involve complex domain knowledge and can instruct the agent on how to chain the available APIs to obtain the relevant outputs to answer the user query. The example query can be “What is my manager's contact information?” The context information can include “Person Id: 123456” and “Current date: 2024.07.10”. Additionally or alternatively, the design query 422 can indicate available tools that can be used to address the user query.

The design query 422 can be provided to the agent to allow the agent to try to answer the user query with the standard agent toolkit. In the example-based plan bank configuration approach, the design query 422 can include this example of a complex user query along with direct instructions to the agent such as a plan in natural language and any implicit API chaining specified. The agent can provide, such as via the design LLM 604, a proposed action plan, such as the agent plan execution steps 606, with API chaining to achieve the final goal. The agent may execute the proposed action plan. In some embodiments, the action plan 406 can include placeholders that can be filled in with the succeeding API calls. The design user 602 may be provided an opportunity to validate or adjust the final answer, such as the output composite tool 610, returned by the agent to assess for accuracy during the setup stage and make any corrections.

In some embodiments, and as a first step of the plan bank framework, the natural language instruction can be converted to a structured action plan. Different natural language instruction formats can be tried and routing agent capability can be reviewed in translating it into the expected API tool chains. Then, a general natural language instruction format can be formulated. When providing the instructions, the API tool names and the argument names can be explicitly provided to avoid any confusion for the agent. Then, a fine-tuned routing agent can be used to formulate the action plan. The action plan can be or include the output composite tool 610 that can have chained tools, or APIs thereof, and the action plan can include proposals for a tool name, a tool description, and input arguments for the action plan.

The design user 602 can review and edit the tool name, tool description, input argument names and input argument descriptions of the action plan to make sure that the new tool is a distinguishable composite API tool that does not overlap with the nested API calls within the tool. The tool description for the composite tool may be generated in such a way that the tool description does not negatively affect the standard toolkit routing. When a composite tool is added to the plan bank 406, it may compete with existing tools during the routing step. Explicitly specifying the internal API tools are superseded by the new tool in the description can help to avoid any complications to the routing agent 404. This additional information can be added at the end of the tool description such as via “This tool supersedes Tool A, Tool B and Tool C etc.” Once the action plan reaches a successful final answer, the action plan can be saved as a composite API tool into the plan bank 406 that can be readily used by the digital assistant to answer any similar user query.

Flowchart for a Routing Agent with a Plan Bank for Digital Assistant

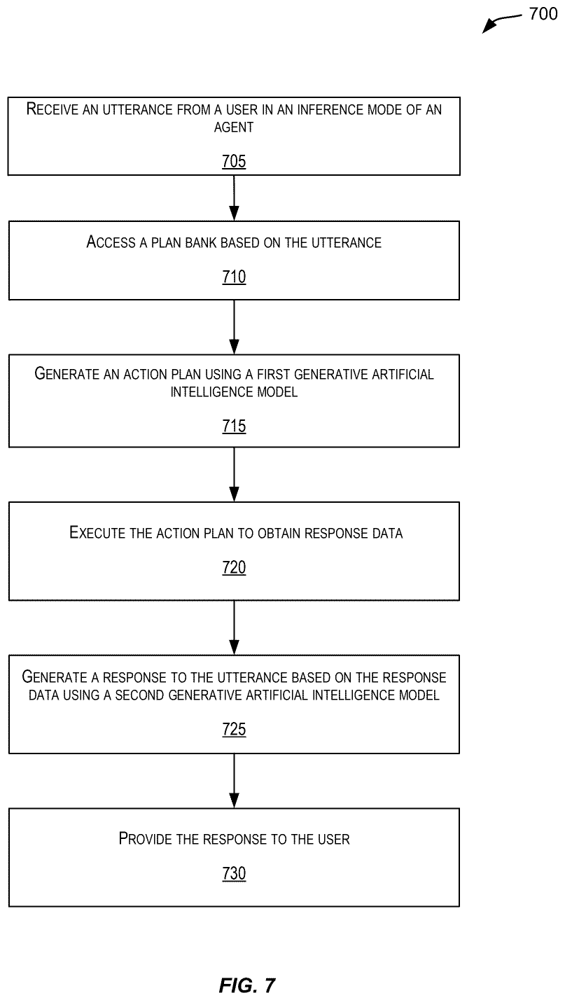

FIG. 7 is a flowchart of a process 700 for using a plan bank of API chains for routing an utterance using a generative model-based digital assistance, in accordance with various embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 7 and described below is intended to be illustrative and non-limiting. Although FIG. 7 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 7 may be performed by one or more of the components, computing devices, services, or the like, such as the digital assistant, the generative model (LLMs), etc., illustrated and described with respect to FIGS. 1-6.

At block 705, an utterance 402 is received from a user of a digital assistant. The utterance 402 may be or include natural language input provided by the user of the digital assistant to the digital assistant such as via an interaction with a user interface provided by the digital assistant. In some embodiments, the utterance 402 may be provided to the digital assistant in an inference phase 418 of the digital assistant. That is, the digital assistant, or any component (e.g., the plan bank 406) thereof, may have previously been configured in a design phase of the digital assistant. The utterance 402 may include or indicate a request by the user for an action to be performed.

At block 710, the plan bank 406 can be accessed. In some embodiments, the digital assistant may include multiple different plan banks, and the digital assistant can use the utterance 402 to select the plan bank 406 as the most relevant plan bank. The plan bank 406 can include a set of tools, such as tool A 402a, tool B 402b, tool C 402c, composite tool A 404a, and composite tool 404b. The plan bank 406 can include one or more composite tools that can include chained APIs or other calls that may be more complex than a base tool. In some embodiments, a composite tool can include (i) a chain of tools include API tools, other composite tools, or any combination thereof and (ii) associated logic that can include business logic, input-output logic, conditional logic, or any combination thereof. In some embodiments, the chain of tools is a predefined sequence of the API tools, the other composite tools, or any combination thereof, and the associated logic includes business logic, input-output logic, conditional logic, or any combination thereof for completing one or more tasks using the one or more actions associated with each of the API tools, the other composite tools, or any combination thereof.

At block 715, an action plan is generated based on the utterance 402 and the plan bank 406. In some embodiments, the action plan can be generated by a first generative artificial intelligence model. The first generative artificial intelligence model can receive the utterance 402 and the plan bank 406 and can generate the action plan by selecting at least one composite tool of a set of composite tools included in the plan bank 406. In some embodiments, the first generative artificial intelligence model can select the at least one composite tool based on the at least one composite tool being configured to perform a set of tasks for supporting the action indicated by the utterance 402. The action plan can include at least one composite tool, which may be a subset of a set of composite tools included in the plan bank 406. In some embodiments, each of the composite tools of the plan bank 406 can be selected, or any subset of the composite tools may be selected.

At block 720, the action plan is executed to obtain response data. In some embodiments, the action plan can be provided to an execution engine or execution agent for implementing the at least one composite tool. Executing the action plan can involve executing one or more actions or tasks associated with each tool included in the at least one composite tools. For example, the execution engine can identify each API call indicated by each tool included in the at least one composite tool, and the execution engine can execute each API call according to associated logic. The outputs or results from execution of each API call can be the response data or can be used to generate the response data.

At block 725, a response to the utterance 402 is generated. In some embodiments, the response can be generated by a second generative artificial intelligence model based on the response data. That is, the response data can be input into the second generative artificial intelligence model, and the second generative artificial intelligence model can generate output that includes the response. In some embodiments, the response includes natural language that is a natural response to the utterance 402.

At block 730, the response is provided to the user. The second generative artificial intelligence model, or other suitable component of the digital assistant, can output the response to the user. For example, the response can be populated on a user interface that is provided to a client device associated with the user.

In some examples, such as prior to receiving the utterance 402, a design query 422 may be received. The design query can include a design instruction from a design user or a different user in a design mode associated with the digital assistant. The design instruction can include an example of the utterance 402, or a substantially similar variant of the utterance 402, and domain knowledge instructions to the agent that explain a chain of logic for executing the one or more actions or tasks to arrive at the response data or a substantially similar variant of the response data for responding to the utterance 402 or the substantially similar variant of the utterance 402. Additionally or alternatively, a third generative artificial intelligence model can generate a composite tool based on the design instruction, and the composite tool can be stored in the plan bank 406.

In some embodiments, the domain knowledge instructions can include (i) the API tools, the other composite tools, or any combination thereof to include in the composite tool, and (ii) a set of arguments to be used by the composite tool for executing the one or more actions associated with each of the API tools, the other composite tools, or any combination thereof. Additionally or alternatively, generating the composite tool can include creating, based on the design instruction, the predefined sequence of the API tools, the other composite tools, or any combination thereof, and the associated logic for the composite tool, and one or more placeholder arguments for the set of arguments to be used by the composite tool for executing the one or more actions. Additionally or alternatively, a fourth generative artificial intelligence model can generate metadata for the composite tool. The metadata can include (i) a name for the composite tool, (ii) a description for the composite tool, and (iii) a list of the arguments to be used by the composite tool for executing the one or more actions associated with each of the API tools, the other composite tools, or any combination thereof associated with the composite tool. The composite tool can be stored in association with the metadata in the plan bank 406.

In some embodiments, the description for the composite tool includes a statement identifying individual tools that are to be superseded by the composite tool. Additionally or alternatively, the first generative artificial intelligence model can generate the action plan based on the plan bank, the utterance, and the metadata. The first generative artificial intelligence model can be a same or different model from that of the second generative artificial intelligence model. Additionally or alternatively, the first generative artificial intelligence model is a same or different model from that of the third generative artificial intelligence model. Additionally or alternatively, the third generative artificial intelligence model is a same or different model from that of the fourth generative artificial intelligence model.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

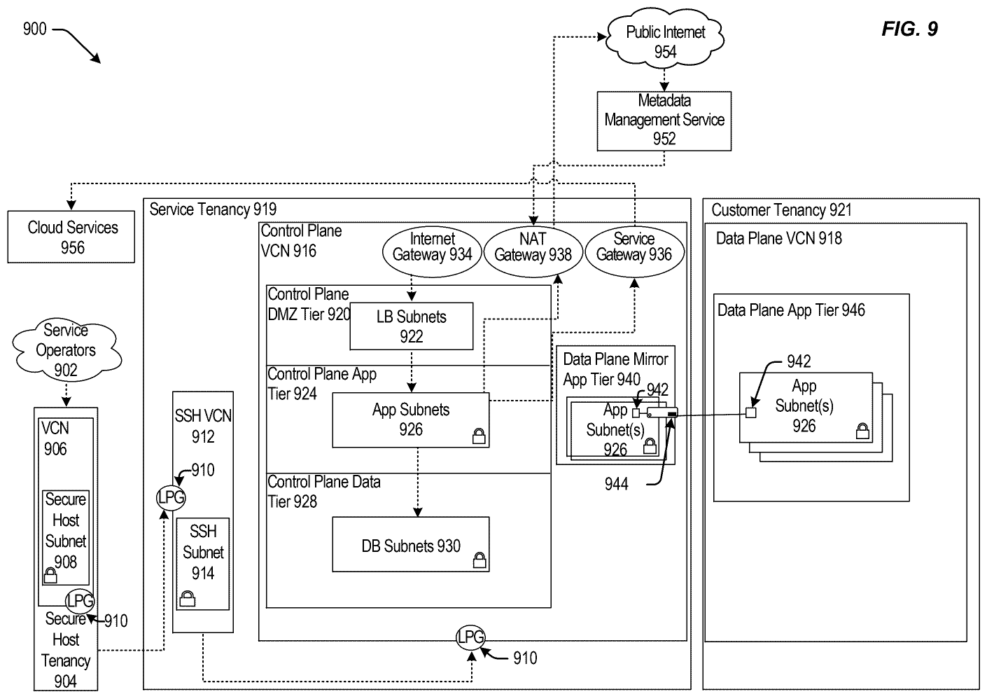

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 6,” may be located in Region 1 and in “Region 2.” If a call to Deployment 6 is made by the service gateway 936 contained in the control plane VCN 916 located in Region 1, the call may be transmitted to Deployment 6 in Region 1. In this example, the control plane VCN 916, or Deployment 6 in Region 1, may not be communicatively coupled to, or otherwise in communication with, Deployment 6 in Region 2.

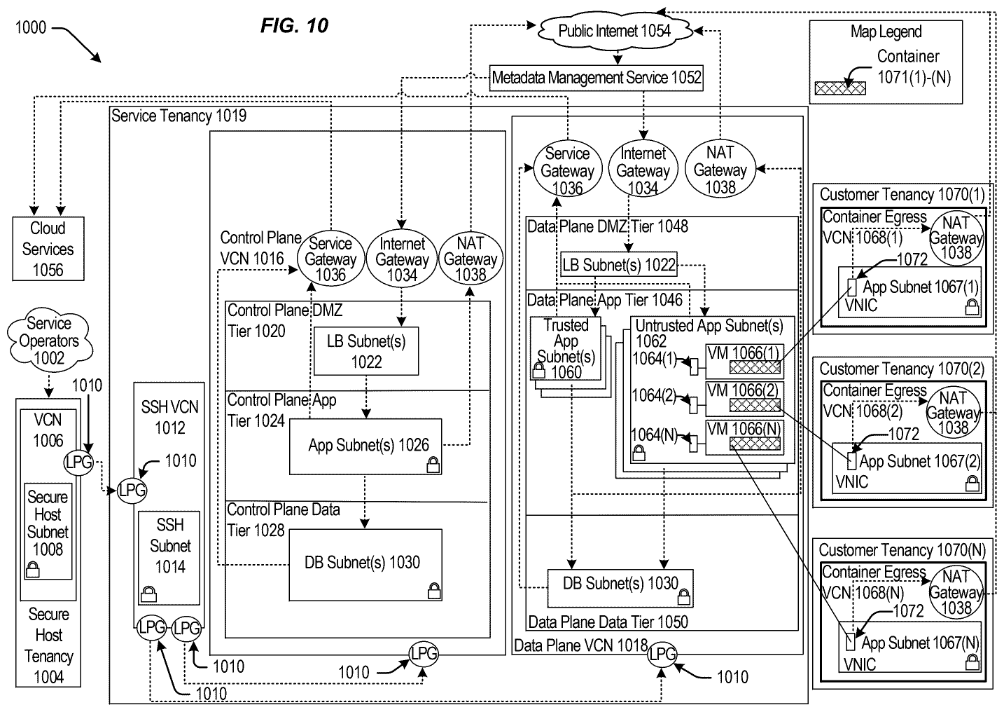

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

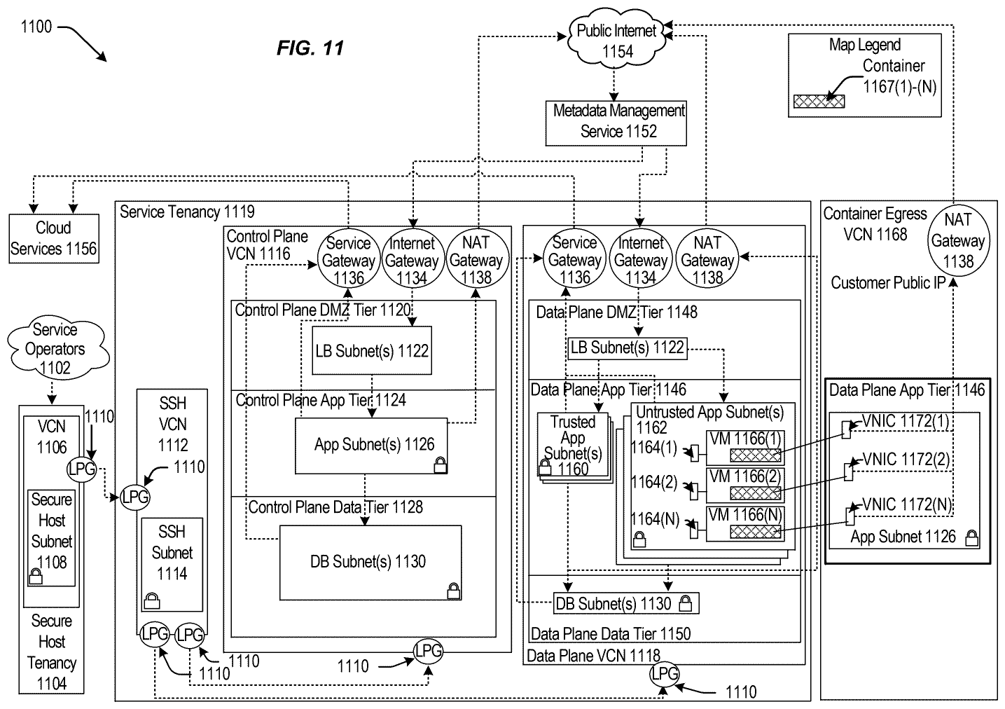

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

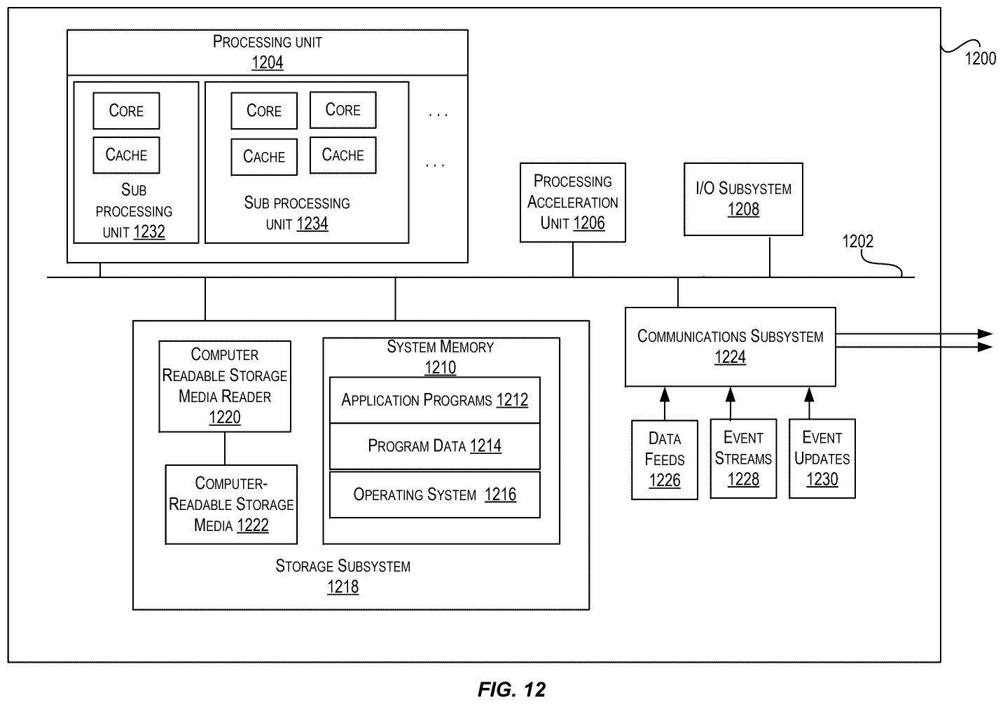

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving an utterance from a user in an inference mode associated with an agent;
accessing, based on the utterance, a plan bank that comprises a plurality of tools comprising one or more composite tools, wherein each of the one or more composite tools comprises: (i) a chain of tools including: a plurality of application programming interface (API) tools, a plurality of other composite tools, or any combination thereof, and (ii) associated logic;
generating, by a first generative artificial intelligence model based on the plan bank and the utterance, an action plan comprising a composite tool of the one or more composite tools;
executing the action plan to obtain response data, wherein executing the action plan comprises executing one or more actions associated with each of the plurality of API tools, the plurality of other composite tools, or any combination thereof associated with the composite tool based on the associated logic to obtain the response data;
generating, by a second generative artificial intelligence model, a response to the utterance based on the response data; and
providing the response to the user.

2. The computer-implemented method of claim 1, wherein the chain of tools is a predefined sequence of the plurality of API tools, the plurality of other composite tools, or any combination thereof, and the associated logic includes business logic, input-output logic, conditional logic, or any combination thereof for completing one or more tasks using the one or more actions associated with each of the plurality of API tools, the plurality of other composite tools, or any combination thereof.

3. The computer-implemented method of claim 1, further comprising:
prior to receiving the utterance from the user in the inference mode, receiving a design instruction from the user or a different user in a design mode associated with the agent, wherein the design instruction comprises the utterance or a substantially similar variant of the utterance and domain knowledge instructions to the agent that explain a chain of logic for executing the one or more actions to arrive at the response data or a substantially similar variant of the response data for responding to the utterance or the substantially similar variant of the utterance;
generating, by a third generative artificial intelligence model based on the design instruction, the composite tool; and
storing the composite tool in the plan bank.

4. The computer-implemented method of claim 3, wherein:
the domain knowledge instructions comprise: (i) the plurality of API tools, the plurality of other composite tools, or any combination thereof to include in the composite tool, and (ii) a set of arguments to be used by the composite tool for executing the one or more actions associated with each of the plurality of API tools, the plurality of other composite tools, or any combination thereof; and
generating the composite tool comprises creating, based on the design instruction, a predefined sequence of the plurality of API tools, the plurality of other composite tools, or any combination thereof, and the associated logic for the composite tool, and one or more placeholder arguments for the set of arguments to be used by the composite tool for executing the one or more actions.

5. The computer-implemented method of claim 4, further comprising generating, by a fourth generative artificial intelligence model based on the design instruction, metadata for the composite tool, wherein the metadata comprises: (i) a name for the composite tool, (ii) a description for the composite tool, and (iii) a list of the arguments to be used by the composite tool for executing the one or more actions associated with each of the plurality of API tools, the plurality of other composite tools, or any combination thereof associated with the composite tool, and wherein the composite tool is stored in association with the metadata in the plan bank.

6. The computer-implemented method of claim 5, wherein:
the description for the composite tool includes a statement identifying individual tools that are to be superseded by the composite tool; and
the first generative artificial intelligence model generates the action plan based on the plan bank, the utterance, and the metadata.

7. The computer-implemented method of claim 5, wherein:
the first generative artificial intelligence model is a same or different model from that of the second generative artificial intelligence model;
the first generative artificial intelligence model is a same or different model from that of the third generative artificial intelligence model; and
the third generative artificial intelligence model is a same or different model from that of the fourth generative artificial intelligence model.

8. A system comprising:
one or more processors; and
one or more computer-readable media storing instructions which, when executed by the one or more processors, cause the system to perform operations comprising:
receiving an utterance from a user in an inference mode associated with an agent;
accessing, based on the utterance, a plan bank that comprises a plurality of tools comprising one or more composite tools, wherein each of the one or more composite tools comprises: (i) a chain of tools including: a plurality of application programming interface (API) tools, a plurality of other composite tools, or any combination thereof, and (ii) associated logic;
generating, by a first generative artificial intelligence model based on the plan bank and the utterance, an action plan comprising a composite tool of the one or more composite tools;
executing the action plan to obtain response data, wherein executing the action plan comprises executing one or more actions associated with each of the plurality of API tools, the plurality of other composite tools, or any combination thereof associated with the composite tool based on the associated logic to obtain the response data;
generating, by a second generative artificial intelligence model, a response to the utterance based on the response data; and
providing the response to the user.

9. The system of claim 8, wherein the chain of tools is a predefined sequence of the plurality of API tools, the plurality of other composite tools, or any combination thereof, and the associated logic includes business logic, input-output logic, conditional logic, or any combination thereof for completing one or more tasks using the one or more actions associated with each of the plurality of API tools, the plurality of other composite tools, or any combination thereof.

10. The system of claim 8, wherein the operations further comprise:
prior to receiving the utterance from the user in the inference mode, receiving a design instruction from the user or a different user in a design mode associated with the agent, wherein the design instruction comprises the utterance or a substantially similar variant of the utterance and domain knowledge instructions to the agent that explain a chain of logic for executing the one or more actions to arrive at the response data or a substantially similar variant of the response data for responding to the utterance or the substantially similar variant of the utterance;
generating, by a third generative artificial intelligence model based on the design instruction, the composite tool; and
storing the composite tool in the plan bank.

11. The system of claim 10, wherein:
the domain knowledge instructions comprise: (i) the plurality of API tools, the plurality of other composite tools, or any combination thereof to include in the composite tool, and (ii) a set of arguments to be used by the composite tool for executing the one or more actions associated with each of the plurality of API tools, the plurality of other composite tools, or any combination thereof; and
generating the composite tool comprises creating, based on the design instruction, a predefined sequence of the plurality of API tools, the plurality of other composite tools, or any combination thereof, and the associated logic for the composite tool, and one or more placeholder arguments for the set of arguments to be used by the composite tool for executing the one or more actions.

12. The system of claim 11, wherein the operations further comprise generating, by a fourth generative artificial intelligence model based on the design instruction, metadata for the composite tool, wherein the metadata comprises: (i) a name for the composite tool, (ii) a description for the composite tool, and (iii) a list of the arguments to be used by the composite tool for executing the one or more actions associated with each of the plurality of API tools, the plurality of other composite tools, or any combination thereof associated with the composite tool, and wherein the composite tool is stored in association with the metadata in the plan bank.

13. The system of claim 12, wherein:
the description for the composite tool includes a statement identifying individual tools that are to be superseded by the composite tool; and
the action plan is generatable using the first generative artificial intelligence model and based on the plan bank, the utterance, and the metadata.

14. The system of claim 12, wherein:
the first generative artificial intelligence model is a same or different model from that of the second generative artificial intelligence model;
the first generative artificial intelligence model is a same or different model from that of the third generative artificial intelligence model; and
the third generative artificial intelligence model is a same or different model from that of the fourth generative artificial intelligence model.

15. One or more non-transitory computer-readable media storing instructions which, when executed by one or more processors, cause a system to perform operations comprising:
receiving an utterance from a user in an inference mode associated with an agent;
accessing, based on the utterance, a plan bank that comprises a plurality of tools comprising one or more composite tools, wherein each of the one or more composite tools comprises: (i) a chain of tools including: a plurality of application programming interface (API) tools, a plurality of other composite tools, or any combination thereof, and (ii) associated logic;
generating, by a first generative artificial intelligence model based on the plan bank and the utterance, an action plan comprising a composite tool of the one or more composite tools;
executing the action plan to obtain response data, wherein executing the action plan comprises executing one or more actions associated with each of the plurality of API tools, the plurality of other composite tools, or any combination thereof associated with the composite tool based on the associated logic to obtain the response data;
generating, by a second generative artificial intelligence model, a response to the utterance based on the response data; and
providing the response to the user.

16. The one or more non-transitory computer-readable media of claim 15, wherein the chain of tools is a predefined sequence of the plurality of API tools, the plurality of other composite tools, or any combination thereof, and the associated logic includes business logic, input-output logic, conditional logic, or any combination thereof for completing one or more tasks using the one or more actions associated with each of the plurality of API tools, the plurality of other composite tools, or any combination thereof.

17. The one or more non-transitory computer-readable media of claim 15, wherein the operations further comprise:
prior to receiving the utterance from the user in the inference mode, receiving a design instruction from the user or a different user in a design mode associated with the agent, wherein the design instruction comprises the utterance or a substantially similar variant of the utterance and domain knowledge instructions to the agent that explain a chain of logic for executing the one or more actions to arrive at the response data or a substantially similar variant of the response data for responding to the utterance or the substantially similar variant of the utterance;
generating, by a third generative artificial intelligence model based on the design instruction, the composite tool; and
storing the composite tool in the plan bank.

18. The one or more non-transitory computer-readable media of claim 17, wherein:
the domain knowledge instructions comprise: (i) the plurality of API tools, the plurality of other composite tools, or any combination thereof to include in the composite tool, and (ii) a set of arguments to be used by the composite tool for executing the one or more actions associated with each of the plurality of API tools, the plurality of other composite tools, or any combination thereof; and
generating the composite tool comprises creating, based on the design instruction, a predefined sequence of the plurality of API tools, the plurality of other composite tools, or any combination thereof, and the associated logic for the composite tool, and one or more placeholder arguments for the set of arguments to be used by the composite tool for executing the one or more actions.

19. The one or more non-transitory computer-readable media of claim 18, wherein the operations further comprise generating, by a fourth generative artificial intelligence model based on the design instruction, metadata for the composite tool, wherein the metadata comprises: (i) a name for the composite tool, (ii) a description for the composite tool, and (iii) a list of the arguments to be used by the composite tool for executing the one or more actions associated with each of the plurality of API tools, the plurality of other composite tools, or any combination thereof associated with the composite tool, and wherein the composite tool is stored in association with the metadata in the plan bank.

20. The one or more non-transitory computer-readable media of claim 19, wherein:
the description for the composite tool includes a statement identifying individual tools that are to be superseded by the composite tool;
the action plan is generatable using the first generative artificial intelligence model and based on the plan bank, the utterance, and the metadata;
the first generative artificial intelligence model is a same or different model from that of the second generative artificial intelligence model;
the first generative artificial intelligence model is a same or different model from that of the third generative artificial intelligence model; and
the third generative artificial intelligence model is a same or different model from that of the fourth generative artificial intelligence model.
